(19) United States
(12) Patent Application Publication
(10) Pub. No.: US 2014/0146198 A1
(43) Pub. Date: May 29, 2014

(54) IMAGE PROCESSING DEVICE AND IMAGE PICK-UP DEVICE

(71) Applicants: Keisuke Omori, Osaka-shi (JP); Kei Tokui, Osaka-shi (JP)

(72) Inventors: Keisuke Omori, Osaka-shi (JP); Kei Tokui, Osaka-shi (JP)

(73) Assignee: SHARP KABUSHIKI KAISHA, Osaka-shi, Osaka (JP)

(21) Appl. No.: 14/119,997

(22) PCT Filed: Apr. 25, 2012
(86) PCT No.: PCT/JP2012/061058

§ 371 Date: Nov. 25, 2013

(30) Foreign Application Priority Data
Jun. 8, 2011 (JP) 2011-128322

(51) Int. Cl. H04N 5/225

(52) U.S. Cl. CPC H04N 5/2256
USPC 348/222.1

(57) ABSTRACT

Provided is an image processing device that acquires from an input image a high-quality image that is free from halos and features high contrast from a dark image portion to a light image portion of the image. The image processing device (10) includes an illumination light component calculating unit (12) that calculates from an input image an illumination light component from brightness of a target pixel and brightness of a peripheral pixel. The image processing device (10) thus performs a gradation conversion process in accordance with the illumination light component. In the calculation of the illumination light component, the illumination light component calculating unit (12) acquires distance information indicating a distance to a subject in the input image, varies a weight to brightness in response to a difference between distance information responsive to the target pixel and distance information responsive to the peripheral pixel, and varies an area, referenced as the peripheral pixel, in response to the distance information responsive to the target pixel.

### TECHNICAL FIELD

The present invention relates to an image processing device that gives high-quality video and an image pickup device that incorporates the image processing device.

### BACKGROUND ART

Functionality and image quality have been increased recently in image pickup devices, such as digital still cameras and digital video cameras. One of the factors that determines the image quality of a pickup image is contrast. The term contrast means a difference between a dark portion of the image and a light portion of the image, and a high contrast gives a clear image. Another factor that also determines the image quality is a dynamic range (hereinafter referred to as DR). DR means a ratio of a minimum value of a signal recognizable to a maximum value of the signal. In the following discussion, DR refers to a ratio of maximum luminance to minimum luminance in a pickup scene.

When an image is displayed on a display such as a liquid-crystal display, a brightness range within which the display can represent brightness is subject to a limitation. Depending on an input image and performance of the display, so-called blocked up shadows where a gradation in the dark portion is lost may be caused. By performing a gradation conversion process to increase a pixel value of an original image, the blocked up shadows are overcome, and an image with a clear dark portion results. The increasing of the pixel value causes blown-out highlights where the light portion is saturated, reduces the contrast, and lowers the image quality in the light portion. In particular, when a scene with a high DR is captured, a dark portion and a light portion are likely to be mixed and the above problem is thus likely to occur.

To overcome this problem, a gradation conversion technique based on the retinex theory has been proposed. The retinex theory is a theory based on a model of human vision characteristics. According to the retinex theory, the brightness of an object is determined by a product of reflectance of the object and illumination light, and the vision of the eyes responsive to the brightness of the object is strongly correlated with the reflectance of the object. Therefore, if only an illumination light component of an input image is compressed with a reflectance component of an object maintained in the gradation conversion, a high-contrast image free from blocked up shadows and blown-out highlights can be obtained. It is not easy to accurately discriminate the illumination light component and reflectance from a pickup image. If the possibility that the illumination light continuously varies in actual space is high, a low-frequency component that is obtained by low-pass filtering the input image can be considered to be an illumination light component. A high-contrast image can be obtained by compressing the illumination light component and by multiplying the reflectance component of the input image by the compressed illumination light component.

In practice, however, there are times when the illumination light varies discontinuously. If the gradation conversion process is performed based on the above-described assumption, undershooting and overshooting, referred to as halos, occur in an edge surrounding area where the illumination light sharply changes, and the image is degraded.

The principle on which the halos are generated is described with reference to FIG. 13A through FIG. 13D. FIG. 13A illustrates an example of an image of scene where indoor and outdoor objects are picked up at the same time, in other words, an image of scene where the indoor and outdoor objects coexist. FIG. 13B illustrates a change in brightness at a location of an arrow 131 in an image 130 of FIG. 13A. A graph 132 of FIG. 13B indicates that brightness greatly varies at an edge between the background and the foreground. If a portion labeled the arrow 131 is low-pass filtered to calculate a low-frequency component, brightness is smoothed and a sharp edge is relaxed as illustrated by a graph 133 of FIG. 13C. If a compression process is performed to compress the low-frequency component of the input image in accordance with the calculated low-frequency component, the overshooting and undershooting are created the edge surrounding area as illustrated by a graph 134 of FIG. 13D. The image is thus degraded.

According to PTL 1, the pixel values of a target pixel and a peripheral pixel are compared at a low-pass filter to calculate a low-frequency component, and if a difference between the two pixel values is equal to or above a predetermined threshold value, the target pixel is excluded as a reference target. This arrangement controls the smoothing of the low-frequency component at the edge where the illumination light sharply changes, and the relaxation of the edge. The generation of halos is thus controlled.

### CITATION LIST

### Patent Literature

PTL 1: Japanese Unexamined Patent Application Publication No. 2007-281767

### SUMMARY OF INVENTION

### Technical Problem

According to PTL 1, the target pixel is compared with the peripheral pixel in terms of pixel value, and no consideration is given to whether the difference therebetween is attributed to a difference in illumination light or a difference in reflectance of object. If the illumination light component is calculated through the method of PTL 1, the reflectance component of the object affects the illumination light component in a region where the difference in the illumination light component is small while the difference in the reflectance component of object is large. When the illumination light component is compressed, the reflectance component of object is also compressed. As a result, contrast is decreased, degrading the image.

Referring to FIG. 14A through FIG. 14D, the problem associated with the related art, namely, a decrease in contrast is described below. In an input image 140 of FIG. 14A, a subject greatly varying in reflectance is placed under uniform illumination light. The low-frequency component of the input image 140 is calculated through the method of PTL 1, and a portion labeled an arrow 141 is plotted as a graph 142 of FIG. 14B. The actual illumination light is uniform, but peripheral pixels largely different in pixel value are not accounted for in the calculation. A difference in reflectance thus affects the illumination light component. If the calculated low-frequency component is compressed, the low-frequency component subsequent to conversion is illustrated as a graph 143 of FIG. 14C. A component that is originated from the reflectance component is compressed. As illustrated in FIG. 14D, an output image 144 is decreased in contrast, and image quality is degraded.

The present invention has been developed in view of the above situation, and it is an object of the present invention to provide an image processing device that gives a high-quality image that is free from halos and gives high contrast from a dark portion to a light portion of the image, and an image pickup device that includes the image processing device and processes a pickup image as an input image through the image processing device.

### Solution to Problem

To solve the problem, the present invention of a first aspect relates to an image processing device that calculates an illumination light component of an input image from brightness of a target pixel and brightness of a peripheral pixel in the input image and performs a gradation conversion process on the input image in accordance with the illumination light component. The image processing device varies a weight to brightness on the illumination light component in response to a difference between distance information responsive to the target pixel, calculated from distance information indicating a distance to a subject in the input image, and distance information responsive to the peripheral pixel, calculated from the distance information indicating the distance to the subject in the input image, and calculates an area that is referenced as the peripheral pixel and is different in response to the distance information responsive to the target pixel.

In the present invention of a second aspect in view of the first aspect, the illumination light component is calculated by reducing more in size the area referenced as the peripheral pixel as the distance to the subject represented by the distance information responsive to the target pixel is longer.

In the present invention of a third aspect in view of the first and second aspects, a high-frequency component extracted from the input image is added to an image as a result of the gradation conversion process.

In the present invention of a fourth aspect in view of the first through third aspects, an image pickup device includes the image processing device, wherein an image picked up is input to the image processing device as the input image.

### Advantageous Effects of Invention

The present invention provides a high-quality image that is free from halos and gives high contrast from a dark portion to a light portion in an image.

### BRIEF DESCRIPTION OF DRAWINGS

FIG. 1 is a block diagram illustrating a basic configuration of an image pickup device of the present invention.

FIG. 2 is an external view of an example of the image pickup device of the present invention.

FIG. 3 is a block diagram illustrating a configuration example of the image pickup device of the present invention.

FIG. 4 illustrates a relationship between a distance to a subject and parallax.

FIG. 5A illustrates a process and advantages of the present invention with reference to pixel values of an image.

FIG. 5B illustrates the process and advantages of the present invention with reference to pixel values of an image.

FIG. 5C illustrates the process and advantages of the present invention with reference to pixel values of an image.

FIG. 5D illustrates the process and advantages of the present invention with reference to pixel values of an image.

FIG. 5E illustrates the process and advantages of the present invention with reference to pixel values of an image.

FIG. 5F illustrates the process and advantages of the present invention with reference to pixel values of an image.

FIG. 6A illustrates the process and advantages of the present invention with reference to an actual input image.

FIG. 6B illustrates the process and advantages of the present invention with reference to the actual input image.

FIG. 6C illustrates the process and advantages of the present invention with reference to the actual input image.

FIG. 6D illustrates the process and advantages of the present invention with reference to the actual input image.

FIG. 7A illustrates the process and advantages of the present invention with reference to an actual input image.

FIG. 7B illustrates the process and advantages of the present invention with reference to the actual input image.

FIG. 7C illustrates the process and advantages of the present invention with reference to the actual input image.

FIG. 7D illustrates the process and advantages of the present invention with reference to the actual input image.

FIG. 8 illustrates a relationship between a distance to a subject and parallax in terms of a specific value.

FIG. 9 illustrates an example of a method of compressing an illumination light component in accordance with the present invention.

FIG. 10A illustrates a calculation method of an illumination light component when multiple subjects are present at a long distance.

FIG. 10B illustrates the calculation method of the illumination light component when the multiple subjects are present at the long distance.

FIG. 10C illustrates the calculation method of the illumination light component when the multiple subjects are present at the long distance.

FIG. 10D illustrates the calculation method of the illumination light component when the multiple subjects are present at the long distance.

FIG. 11A is a diagram that relatively compares the size of a region to be filtered and the size of a subject.

FIG. 11B is a diagram that relatively compares the size of the region to be filtered and the size of the subject.

FIG. 11C is a diagram that relatively compares the size of the region to be filtered and the size of the subject.

FIG. 12 illustrates an example of a modification of a filter size to calculate the illumination light component in response to the distance to the subject in accordance with the present invention.

FIG. 13A illustrates the principle on which halos are generated.

FIG. 13B illustrates the principle on which the halos are generated.

FIG. 13C illustrates the principle on which the halos are generated.

FIG. 13D illustrates the principle on which the halos are generated.

FIG. 14A illustrates a contrast decrease associated with the related art.

FIG. 14B illustrates the contrast decrease associated with the related art.

FIG. 14C illustrates the contrast decrease associated with the related art.

FIG. 14D illustrates the contrast decrease associated with the related art.

### DESCRIPTION OF EMBODIMENTS

### First Embodiment

Preferred embodiments of an image pickup device of the present invention are described below with reference to the accompanying drawings.

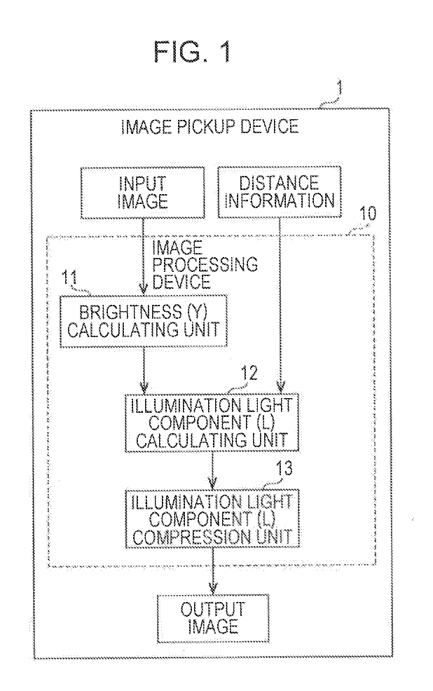

FIG. 1 is a block diagram illustrating the basic configuration of an image pickup device of the present invention. The image pickup device 1 of FIG. 1 includes an image processing device 10 that performs image processing on an input image and distance information. As an ordinary image pickup device, the image pickup device 1 may further include a storage device (not illustrated) that records an image processed by the image processing device 10.

The image processing device 10 includes a brightness (Y) calculating unit 11, an illumination light component (L) calculating unit 12, and an illumination light component (L) compression unit 13. The L calculating unit 11 calculates brightness of a target pixel and brightness of a peripheral pixel in response to an input image. The L calculating unit 12 calculates the illumination light component of the input image based on the brightness of the target pixel and the brightness of the peripheral pixel, calculated by the Y calculating unit 11. Since there are times when the brightness Y is available as information, the Y calculating unit 11 is not an essential element in the image processing device 10.

The image processing device 10 performs a gradation conversion process on the illumination light component calculated by the L calculating unit 12. In the example herein, the L compression unit 13 performs the gradation conversion process by compressing the illumination light component.

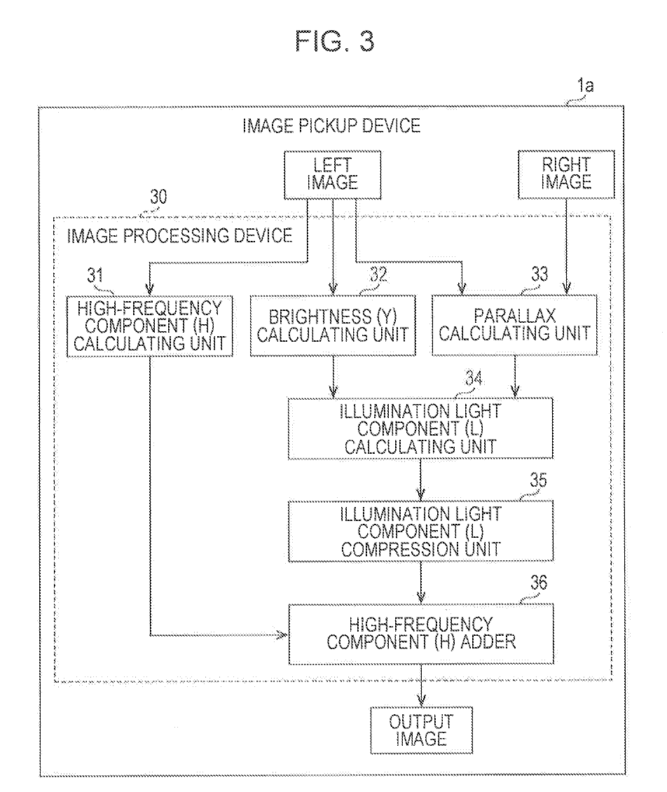

In the main feature of the present invention, the L calculating unit 12 acquires distance information indicating a distance to a subject in the input image in the calculation of the illumination light component, and varies brightness in response to a difference between the distance information of the target pixel and the distance information of the peripheral pixel. In the calculation of the illumination light component, the L calculating unit 12 varies an area that serves as a peripheral pixel, namely, a filtering area in response to the distance information of the target pixel. The units 11 through 13 are described in detail with reference to FIG. 3 and other figures.

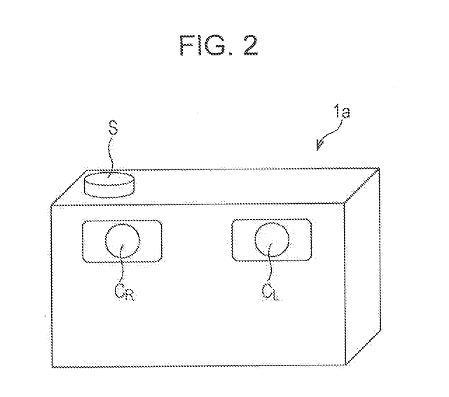

FIG. 2 is an external view of an example of the image pickup device of the present invention. The external view of FIG. 2 is also applicable as an external view of the image pickup device 1 of FIG. 1. As illustrated in FIG. 2, an image pickup apparatus 1a includes a left camera C_{L} and a right camera C_{R} for the left eye and the right eye, respectively. The two cameras C_{L} and C_{R} in the image pickup apparatus 1a respectively pick up two images different in point of view with a shutter S pressed on the image pickup apparatus 1a. Note that the images different in point of view can also be acquired by a single camera with pickup timings shifted by moving the camera manually or with an automatic movement mechanism in the image pickup apparatus.

FIG. 3 is a block diagram illustrating the configuration example of the image pickup device of the present invention, and illustrating the internal configuration of the image pickup apparatus 1a of FIG. 2. The image pickup apparatus 1a of FIG. 3 has a more preferable configuration of the image pickup device 1 of FIG. 1, and an image processing device 30 is substituted for the image processing device 10. The image pickup apparatus 1a of FIG. 3 includes a brightness (Y) calculating unit 32, an illumination light component (L) calculating unit 34, and an illumination light component (L) compression unit 35 respectively corresponding to the Y calculating unit 11, the L calculating unit 12, and the L compression unit 13 in the image processing device 10. The image processing device 30 in the image pickup apparatus 1a further includes a high-frequency component (H) calculating unit 31, a parallax calculating unit 33, and a high-frequency component (H) adder 36.

The left and right cameras C_{L} and C_{R} in the image pickup apparatus 1a acquire a left image and a right image as input images. The left image is input to the H calculating unit 31, the Y calculating unit 32, and the parallax calculating unit 33. The right image is input to the parallax calculating unit 33. The following description is equally applicable even if the left and right images are input in a manner reverse to the manner described above.

The parallax calculating unit 33 calculates parallax from the left and right images as the distance information to the subject. Available as a method of calculation parallax is the block matching method, for example. The block matching method is a method of evaluating a similarity between images. In the block matching method, a given region is selected from one image, a region having the highest similarity with that region is selected from a comparative image, and a deviation in position between the comparison target region and the selected region having the highest similarity becomes parallax. Various evaluation functions to evaluate the similarity are used. For example, in one available method called SAD (Sum of Absolute Difference), a region having a minimum total sum of absolute values of differences in pixel value or in luminance value between two images is selected as a region having the highest similarity.

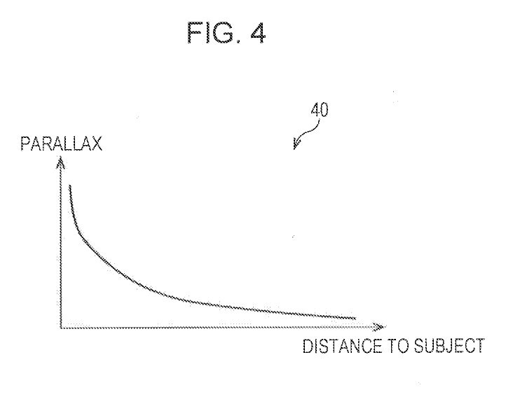

The relationship between a distance to a subject and parallax is described with reference to FIG. 4. Parallax d between the left and right cameras C_{L} and C_{R} is expressed as d=Bf/Z where Z represents the distance to the subject, B represents a baseline length, and f represents a focal length. The parallax d is inversely proportional to the distance Z to the subject. As illustrated by a graph 40 in FIG. 4, the shorter the distance to the subject is, the larger the parallax is, and the longer the distance to the subject is, the smaller the parallax is. The parallax therefore serves as an indicator that represents the distance to the subject. The distance information to the subject may be measured using an infrared sensor mounted on the image pickup device.

When the distance information is used in an image processing process to be discussed later, the input image needs to be associated with the distance information. In view of this necessity, the use of the parallax that results from calculating corresponding points from the images from the left and right cameras C_{L} and C_{R} is better than associating the information from the infrared sensor with the input image.

Next, the Y calculating unit 32 calculates brightness Y of each pixel from the input image. The brightness Y is calculated from the pixel value of the input image. For example, if the input image is a color image having RGB values, Y may be defined using the RGB to YCbCr conversion expression defined by International Telecommunication Union as below.

Y=0.29891×R+0.58661×G+0.11448×B (1)

The brightness Y may be a maximum value of RGB values, namely, Y=Max (R, G, B). The use of the maximum value of the RGB values provides an image quality improvement effect in the gradation conversion process to be discussed below. Note that the calculation of the brightness Y is performed by the Y calculating unit 32 in parallel with, prior to or subsequent to the calculation of the parallax by the parallax calculating unit 33. If information of brightness is available from an illumination sensor or the like in advance, it is not necessary to calculate the brightness from the input image. The input information of brightness may thus be used.

Next, the H calculating unit 31 extracts a high-frequency component H from the input image (the left image in this example), in other words, calculates the high-frequency component H. To calculate the high-frequency component H, a high-pass filter is simply used. For example, a space derivative filter, such as a Sobel filter, is used. The calculation by the H calculating unit 31 may be performed in parallel with, prior to or subsequent to calculation operations of the Y calculating unit 32 and the parallax calculating unit 33.

The L calculating unit 34 calculates the illumination light component L of the input image. The calculation method of the L calculating unit 34 is described below. The illumination light component L is calculated by smoothing the brightness Y. When a smoothing operation is performed in a predetermined region (in a filter), a difference between a distance to a subject image-picked up by a pixel used to calculate the illumination light component L in the center of the filter (hereinafter referred to as a target pixel) and a distance to the subject image-picked up by a pixel around the target pixel (hereinafter referred to as a peripheral pixel) in the filter is calculated from the distance information, and brightness is weight-averaged in accordance with the difference. The parallax may be used as the distance information. In such a case, a weight of the weigh-averaging is increased when the parallax is smaller. When the parallax is smaller, the subject is considered to be at a shorter distance in actual space and the difference in the illumination light component L is considered to be smaller. The weight of the weigh-averaging is decreased when the parallax is larger. When the parallax is larger, the subject is considered to be at a longer distance in the actual space and the difference in the illumination light component L is considered to be larger.

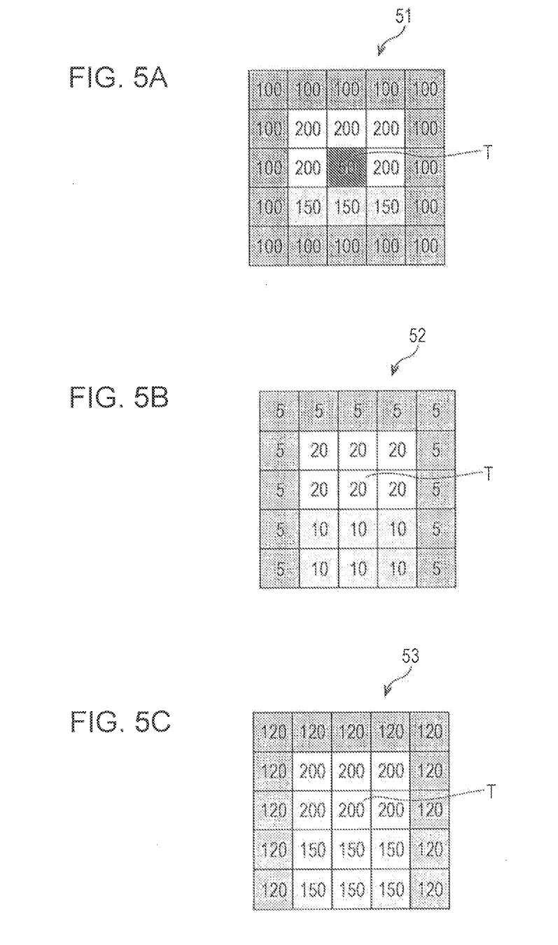

Described below with reference to FIG. 5A through FIG. 5F is how to calculate the illumination light component L of the target pixel using a 5×5 filter as an example of filter. The process mainly in terms of calculation and the advantages of the present invention are described. The pixel values of a specific image are described with reference to FIG. 5A through FIG. 5F, and the same advantages are provided on different pixel values.

Pixel values 51 of the image of FIG. 5A indicate the brightness Y of the input image within a filter area centered on a target pixel T. Parallax values 52 of FIG. 5B are pixel values of the same input image. The illumination light components L of FIG. 5C and reflectance components R of FIG. 5D are correct values of the illumination light component L and correct values of the reflectance components R, respectively. The product of each illumination light component L of FIG. 5C and each reflectance component R of FIG. 5D is the pixel value 51 of FIG. 5A.

The pixel values 51 of FIG. 5A are simply averaged with reference to the target pixel T as below.

L=(50×1+100×16+150×3+200×5)/25=124

Whether to set a pixel as a target for smoothing is determined in accordance with the brightness thereof (a difference in brightness from the target pixel T) using the method described in PTL 1. The weight of a pixel that serves as a target for smoothing is set to be 1, and the weight of a pixel that does not serve as a target for smoothing is set to be 0. For example, if a difference of a pixel value as to whether to smooth is 75, the weight has a weight coefficient 55 of FIG. 5E. If smoothed, the illumination light component L is

$$\begin{matrix}L = ( 50 \times 1.0 \times 1 + 100 \times 1.00 \times 16 + 150 \times 0.00 \times 3 + 200 \times 0.00 \times 5 ) / \\ ( 1.0 \times 1 + 1.00 \times 16 + 0.00 \times 3 + 0.00 \times 5 ) \\ = 97\end{matrix}$$

The illumination light component L becomes substantially smaller than the correct value “200” of the target pixel T of FIG. 5C.

On the other hand, in accordance with the present embodiment, weight coefficients 56 are calculated in accordance with the parallax values 52 of FIG. 5B as illustrated in FIG. 5F, and the illumination light components L are weight-averaged with the weight coefficients 56 for smoothing. The result is

L=(50×1.0×1+100×0.25×13+100×0.50×3+150×0.5×3+200×1.00×5)/(1.0×6+0.50×6+0.25×13)=143

It is thus understood that an illumination light component L close to the correct value is calculated in comparison with the related-art method. More specifically, a high-quality illumination light component L with the reflectance components R separated therefrom is calculated. In the example described herein, the weight coefficient 56 is determined as being proportional to the parallax value 52. The embodiment is not limited to this. It is acceptable if the weight coefficient 56 accounts for the tendency of the parallax value 52.

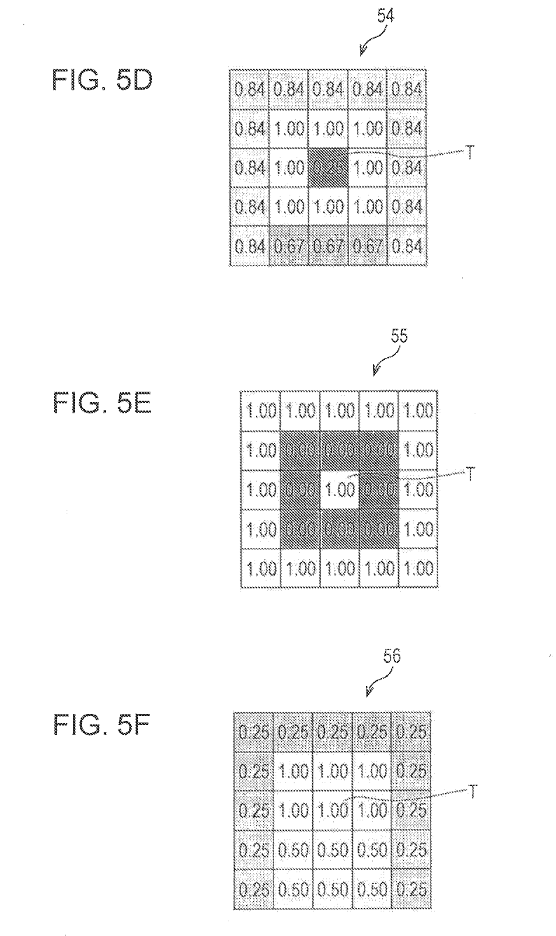

To help understand the advantages of the present invention, the input image that the process and advantages of the present invention are applied to is described with reference to FIG. 6A through FIG. 6D. If the illumination light component L of an input image 61 of FIG. 6A is calculated through the method of the present embodiment, an image 63 with the illumination light component L of FIG. 6C results. A parallax image 62 of FIG. 6B indicates parallax of the image 61 of FIG. 6A. The brighter the image is, the larger the parallax value is, and the shorter the distance to the subject is. The darker the image is, the smaller the parallax value is, and the longer the distance to the subject is. If the image 63 of the illumination light component L is compared with the parallax image 62, it is understood that the illumination light component L sharply changes in the edge surrounding area between an indoor portion at a shorter distance and an outdoor portion at a longer distance.

To verify the advantages of the present invention, the illumination light component L is calculated using a simple smoothing filter as a comparative example, and an image 64 of the illumination light component L of FIG. 6D results. The image 63 of the illumination light component L calculated in accordance with the present embodiment as illustrated in FIG. 6C includes the illumination light component L that sharply changes in the edge surrounding area between the indoor portion and the outdoor portion. If the simple smoothing filter is used, the illumination light component L mildly changes in the edge surrounding area in the image 64 of FIG. 6D, and this becomes a cause of halos.

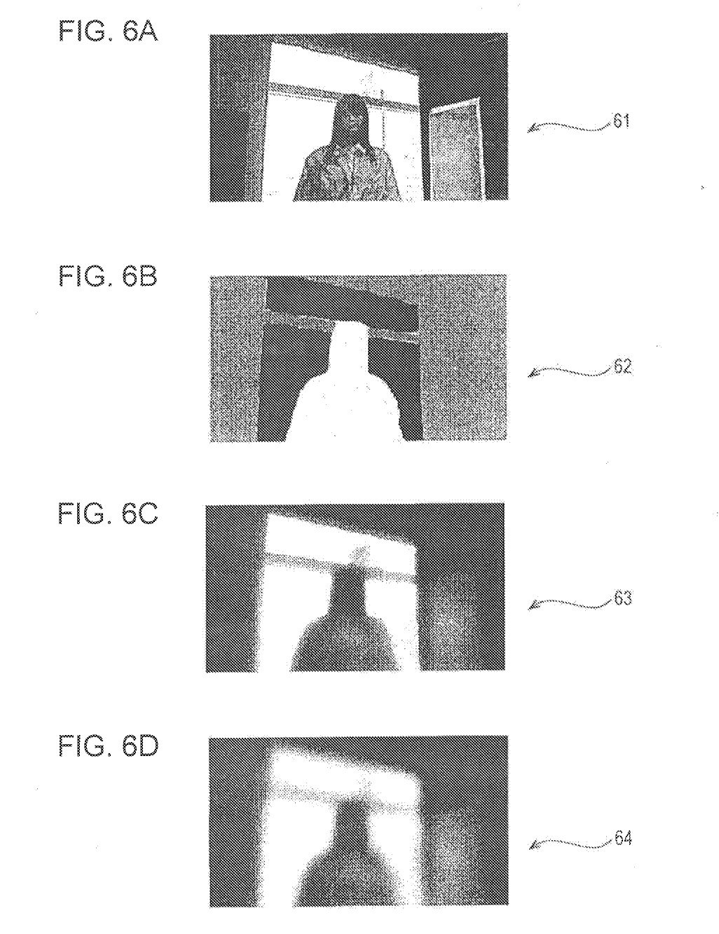

Input images that the process and advantages of the present invention (different from the input images of FIG. 6A through FIG. 6F) are applied to are described with reference to FIG. 7A through FIG. 7D. If the illumination light component L of an input image 71 of FIG. 7A is calculated through the method of the present embodiment, an image 73 of the illumination light component L of FIG. 7C results. A parallax image 72 of FIG. 7B indicates parallax of the input image 71 of FIG. 7A, and indicates that the brighter the image is, the larger the parallax is, and the shorter the distance to the subject is, and that the darker the image is, the smaller the parallax value is, and the longer the distance to the subject is. In comparison with the parallax image 72, the illumination light component L of the image 73 sharply changes in the edge surrounding area between a subject (zebra) at a shorter distance and the background at a longer distance, and the illumination light component L in the region corresponding to the zebra becomes substantially uniform.

To verify the advantages of the present invention, the illumination light component L is calculated through the method described in PTL 1 as a comparative example, and an image 74 of the illumination light component L of FIG. 7D results. In the image 73 of the illumination light component L calculated in accordance with the present embodiment as illustrated in FIG. 7C, the illumination light component L of the subject at the shorter distance becomes substantially uniform. If the illumination light component L is processed through the method described in PTL 1, it is understood that the illumination light component L of the subject at the shorter distance is not smoothed as illustrated by an image 74 of FIG. 7D, and that the reflectance components R is contained in the illumination light component L. In accordance with the method described in PTL 1 in this way, if the illumination light components L are compressed, the reflectance components R are also compressed. A low contrast thus results.

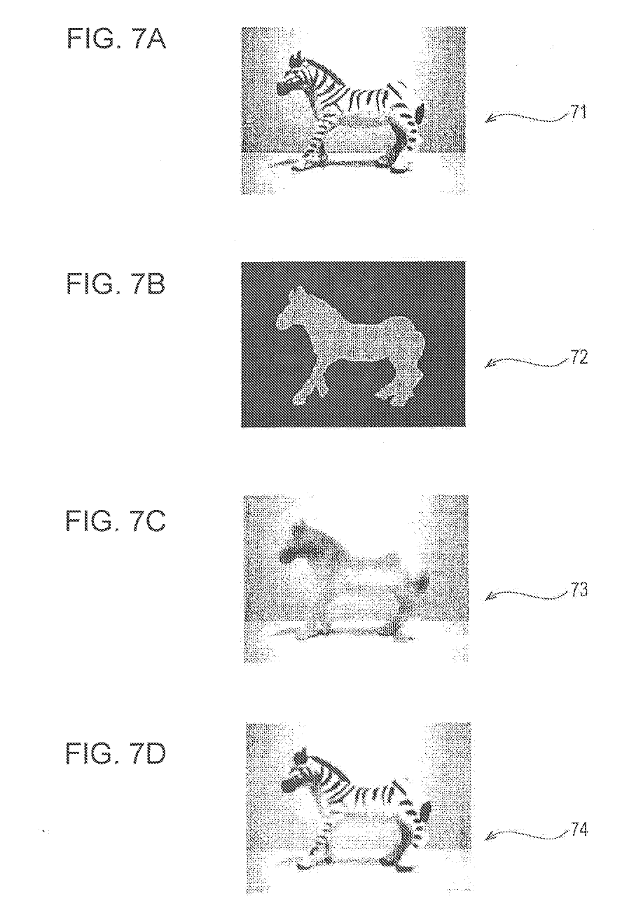

The weighting with the distance information used as the parallax is described in more detail with reference to FIG. 8. FIG. 8 illustrates the relationship between the distance to the subject and the parallax represented in specific values. As illustrated by the graph 40 of FIG. 4, as the distance to the subject becomes longer, the parallax between the images of the left and right cameras C_{L} and C_{R} becomes smaller, and an amount of change in the parallax responsive to an amount of change in the distance to the subject also becomes smaller. For example, an amount of change of parallax by “1” in the shorter distance and an amount of change of parallax by “1” in the longer distance result in differences in distance in actual space. For example, the relationship between the distance to the subject and the parallax may be represented by a graph 80 as illustrated in FIG. 8. Parallax “10” and parallax “9” result in a small difference in distance in the actual space, but parallax “2” and parallax “1” result in a large difference in distance in the actual space. Even if the differences in parallax are equally “1”, the differences in distance become different in the actual space. In the weighting, the parallax value of the target pixel and the magnitude of a difference in parallax between the target pixel and the peripheral pixel are together considered. If the parallax is used as the distance information, the weighting is performed with the difference in distance in the actual space accounted for.

For example, a weight W in the calculation of the illumination light component L may be defined by the following Expression (2). Here Dij represents parallax of the target pixel, |Dij−Di+k,j+l| represents a difference between the parallax of the target pixel and the parallax of the peripheral pixel, and k and l respectively represent variables representing displacements of a reference pixel from the target pixel in a horizontal direction and a vertical direction in the filter. In Expression (2), an example of a weighting function W is parallax Dij. Even if information representing distance, different from the parallax as the distance information, is used, the same weighting function may be used.

$$\begin{matrix} [ Math . 1 ] & \\ {W}_{i + k , j + 1} = 1 - \frac{/ {D}_{ij} - {D}_{i + k , j + 1} /}{{D}_{ij}} \\ ( if {D}_{ij} = 0 , {W}_{i + k , j + 1} = 1 ( {D}_{i + k , j + 1} = 0 ) \\ {W}_{i + k , j + 1} = 0 ( {D}_{i + k , j + 1} \neq 0 ) ) \\ ( if \frac{/ {D}_{ij} - {D}_{i + k , j + 1} /}{{D}_{ij}} > 1 , {W}_{i + k , j + 1} = 0 ) & ( 2 )\end{matrix}$$

If the parallax of the target pixel is “10” and the parallax of the peripheral pixel is “9”, the difference from the parallax “10” is “1”. The weight is 1−1/10=0.9. If the parallax of the target pixel is “2” and the parallax of the peripheral pixel is “1”, the difference from the parallax “2” is “1”. The weight is 1−1/2=0.5. Even if the differences of parallax are the same value, the weight accounts for the difference in distance in the actual space.

A calculation method of the illumination light component L accounting for the difference in distance between the target pixel and the peripheral pixel is expressed by the following Expression (3).

$$\begin{matrix}[ Math . 2 ] & \\ {L}_{ij} = \frac{{\sum }_{i = - k / 2}^{k / 2} {\sum }_{j = - 1 / 2}^{1 / 2} ( {Y}_{ij} * W ( {D}_{ij} , \vert {D}_{ij} - {D}_{i + k , j + 1} \vert ) )}{{\sum }_{i = - k / 2}^{k / 2} {\sum }_{j = - 1 / 2}^{1 / 2} W ( {D}_{ij} , \vert {D}_{ij} - {D}_{i + k , j + 1} \vert )} & ( 3 )\end{matrix}$$

Herein, Dij represents the distance information of the target pixel, |Dij−Di+k,j+l| represents a difference between the distance information of the target pixel and the distance information of the reference pixel, and k and l respectively represent sizes of the filter in the horizontal direction and in the vertical direction. Also, W(Dij, |Dij−Di+k,j+l|) is a weighting function of variables Dij and |Dij−Di+k,j+l|.

In the present embodiment as described above, the difference in distance between the target pixel and the peripheral pixel is accounted for in the calculation of the illumination light component L. An excellent illumination light component is calculated in a scene, such as the input image 61 of FIG. 6A or the input image 71 of FIG. 7A, where the related-art calculation method might cause the reflectance components to affect the illumination light component.

Next, the gradation conversion process is described. Since the brightness of an object is determined by the produce of the reflectance and the illumination light of the object, the brightness Y of the input image is expressed using the illumination light component L and the reflectance component R as below.

Y=R×L (4)

Let Y′ represent the brightness of an image, L′ represent an illumination light component L, and R′ represent a reflectance component, subsequent to the gradation conversion, and the brightness Y′ of the image is expressed as below.

Y′=R′×L′ (5)

In the present embodiment, the gradation conversion is performed so that only the illumination light component L of the input image is compressed with the reflectance component R maintained. More specifically, the gradation conversion is simply performed so that the reflectance component R remains unchanged at the gradation conversion, and it is thus sufficient if the relationship expressed by the following Expression (6) holds.

R=R′ (6)

If the reflectance component is eliminated from Expressions (4) through (6), the following Expression results.

Y′=Y×L′/L (7)

The brightness Y of the image subsequent to the gradation conversion is expressed by only the brightness Y of the input image, the illumination light component L, and the illumination light component L′ of the image subsequent to the gradation conversion. If the illumination light component L′ subsequent to the gradation conversion is defined, the gradation conversion process may be performed with the reflectance component maintained without the need to calculate the reflectance component.

Next, the definition of the illumination light component L′ is described. In the present embodiment, the L compression unit 35 of FIG. 3 performs the gradation conversion process to compress the illumination light component. More specifically, the illumination light component L′ is defined to compress the illumination light component L.

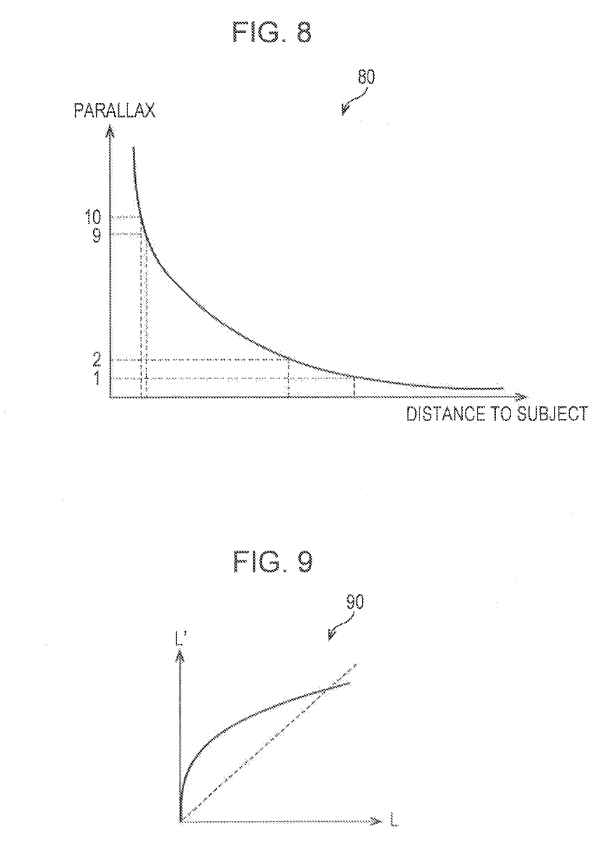

Referring to FIG. 9, an example of the compression method is described. As illustrated in FIG. 9, if the illumination light component L′ is convex upward with respect to the illumination light component L as represented by a graph 90, a dark portion becomes brighter, the brightness of a light portion is restrained, and the illumination light component is compressed. The graph 90 represents an example of conversion values individually determined for each gradation value. Since the way the image looks becomes different depending on the performance of each display device, several patterns of a gradation conversion table of the graph 90 may be stored and an optimum table may be selected in accordance with the display device.

The compression process may be performed on a color image having RGB values. Pixel values R′G′B′ subsequent to the gradation conversion are obtained by multiplying the pixel values RGB of the input image by L′/L as expressed by the following Expressions (8) through (10).

R′=R×L′/L (8)

G′=G×L′/L (9)

B′=B×L′/L (10)

Y′ is calculated in accordance with R′G′B′ and Expression (1) as below.

$$\begin{matrix}{Y}^{′} = 0.29891 \times {R}^{′} + 0.58661 \times {G}^{′} + 0.11448 \times {B}^{′} \\ = ( 0.29891 \times R + 0.58661 \times G + 0.11448 \times B ) {L}^{′} / L \\ = Y \times {L}^{′} / L\end{matrix}$$

This expression satisfies Expression (7).

If the brightness Y is defined as a maximum value of RGB values, Expression (7) is also satisfied. The brightness Y as the maximum value of the RGB values provides the following effect in a high saturation region. For example, the brightness Y of a pixel having a high saturation, for example, having RGB values (R,G,B)=(10, 10, 255), is calculated in accordance with Expression (1). Then, Y=38, and if the maximum value of the RGB values are used, Y=255. If the brightness Y is calculated in accordance with Expression (1) to brighten a dark portion in the gradation conversion process, a process to brighten the dark portion is performed, and the B value is already saturated. In this case, there is a possibility that only the R and G values are increased and that the saturation is decreased. On the other hand, if the maximum value of the RGB value is used as the brightness Y, the pixel is treated as a saturated and bright pixel, and the brightness is restrained. The saturation is not decreased. Therefore, if the gradation conversion process is performed in accordance with Expressions (8) through (10), it is preferable that the maximum value of the RGB values is used as the brightness Y.

The compression of the illumination light component in the gradation conversion process results in an image that is clear in the image from the dark portion to the light portion thereof. Since the difference in the value of the illumination light component L between adjacent pixels in a region where L is continuous is small, in other words, a difference in L′/L is also small between the adjacent pixels, the contrast between the adjacent pixels is maintained through the gradation conversion process. A high-quality image having a high contrast from the dark portion to the light portion thus results.

The filter size used in the illumination light component calculation is varied in response to the distance to the subject in the process of the L calculating unit 34 of FIG. 3. A further image quality improvement effect results. This process is specifically described.

A filter of a size to at least modest degree is preferable because if the filter size is too small in the calculation of the illumination light component, the illumination light component may be insufficiently smoothed. However, if the filter size is large, a difference in distance of a subject at a long distance is difficult to detect even if the illumination light changes sharply in the actual space. As a result, the illumination light component is smoothed, and the edge is relaxed, causing halos. In fact, a calculation unit of distance information, such as an infrared sensor, or the left and right cameras C_{L} and C_{R} (i.e., stereo camera), provides a low calculation resolution at a long distance. For example, as illustrated by the graph 40 of FIG. 4, the longer the distance to the subject is, the smaller the change in parallax responsive to a change in distance becomes. The resolution of the parallax to the distance decreases, and the parallax converges at a distance equal to or above a given threshold value. Two subjects may be now present at different long distances. If the two subjects are preset at different distances in this way, a difference in distance may not be detected in the distance information.

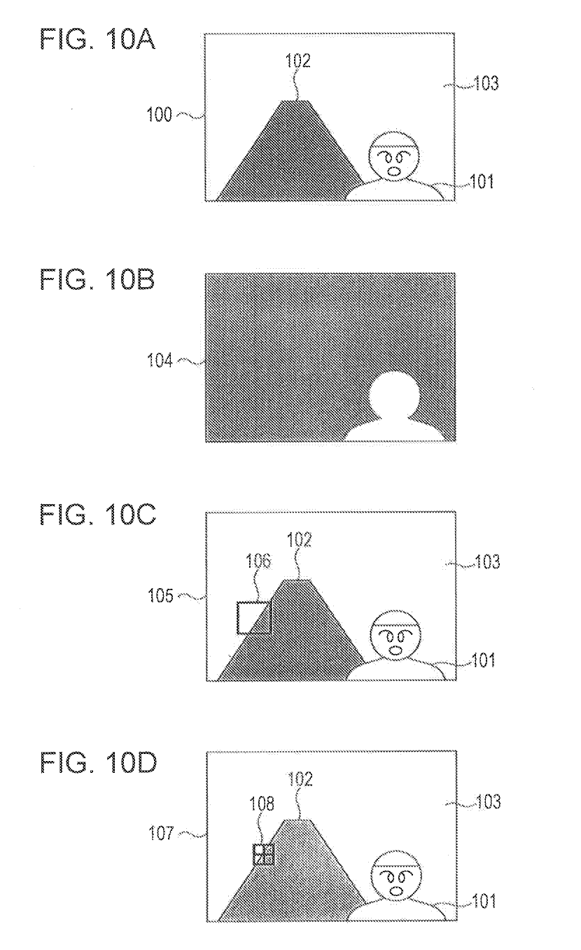

The calculation method of the illumination light component calculation of multiple subjects at long distances is described with reference to FIG. 10A through FIG. 10D. An input image 100 of FIG. 10A includes a subject 101 in the foreground, and two subjects 102 and 103 in the background. In this example, the two subjects are present at the long distance. If three or more subjects are present, the process described below is applicable. An image representing distance information of the input image 100 is a distance image 104 of FIG. 10B. The distance image 104 represents that the brighter color means the shorter distance to the subject.

Although the subject 102 and the subject 103 are present at different distances in the actual space, these two subjects are at the same distance in the input distance information as illustrated by the distance image 104 of FIG. 10B. The illumination light component may be calculated using the input image 100 of FIG. 10A and the distance image 104 of FIG. 10B. Since the subject 101 and the subject 102 are different in the distance information and the subject 101 and the subject 103 are different in the distance information, a distance difference is thus detected. On the other hand, the subject 102 and the subject 103 are not different in the distance information, and the subject 102 and the subject 103 are treated as the subjects at the same distance within a filter 106 as illustrated by an image 105 of FIG. 10C (the input image 100 of FIG. 10A with the filter included). The illumination light components in regions different in illumination light can be smoothed in calculation in the actual space.

If the distance to the subject is long in the present invention, the filter size is reduced as illustrated by a filter 108 in an image 107 of FIG. 10D (an input image 100 of FIG. 10A with the reduced filter included). In the calculation of the illumination light component, multiple subjects at the different distances in the actual space are thus prevented from being treated as subjects at the same distance. As a result, even if multiple subjects different in illumination light are present at a distance too far to identify distance from the distance information, satisfactory illumination light components that account for a sharp change in the illumination light in the actual space can be calculated. The use of a distance adaptive filter that varies the filter size in accordance with the distance information prevents the subjects different in distance in the actual space from being treated as the subjects at the same distance in the calculation of the illumination light component.

The possibility that a filter having a too small size causes the illumination light components not to be sufficiently smoothed has been discussed. Since a filtering region per unit filter size in the actual space expands more as the distance to the subject becomes longer. A sufficient region is filtered in the actual space with the distance to the subject being long even if the filter size is reduced.

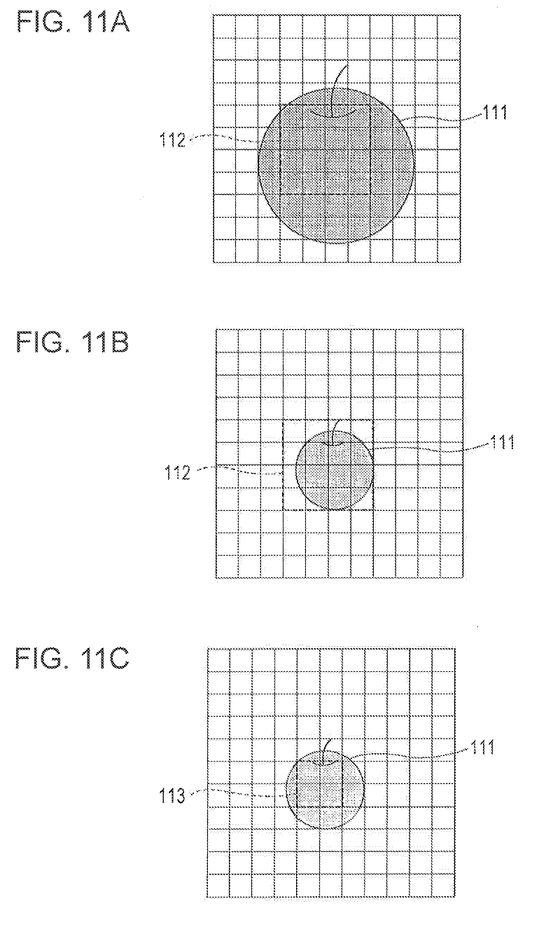

This point is described further with reference to FIG. 11A through FIG. 11C. FIG. 11A through FIG. 11C are diagrams that relatively compare the size of a region to be filtered and the size of a subject. FIG. 11A illustrates a pickup image of a subject 111 that has been picked up at a short distance. FIG. 11B illustrates a pickup image of the subject 111 that has been picked up at a long distance. As illustrated in FIG. 11A through FIG. 11C, each square cell represents one pixel, and an image of 11×11 pixels is illustrated for convenience of explanation. In FIG. 11A, the subject 111 is picked up in a large size, and In FIG. 11B, the subject 111 is picked up in a small size. In FIG. 11A and FIG. 11B, a filter 112 for use in the illumination light component calculation has a size of 4×4 and is denoted by a broken-lined box.

The subject 111 is relatively compared in size with the filter 112. In FIG. 11A, part of the subject 111 is filtered, and in FIG. 11B, the entire subject 111 is filtered. More specifically, given the same filter size, the filtering region in the actual space expands as the distance to the subject increases. If the filter size for use in the illumination light component calculation is reduced in response to the distance to the subject, the same region in the actual space can be filtered. For example, referring to FIG. 11B, the filter 113 of FIG. 11C having a filter size of 2×2 can filter the region in the actual space identical to the filter having a size of 4×4 in FIG. 11A. As described above, even if the filter size for use in the illumination light component calculation is reduced in response to the distance to the subject, the region in the actual space sufficient to smooth the illumination light component can be filtered.

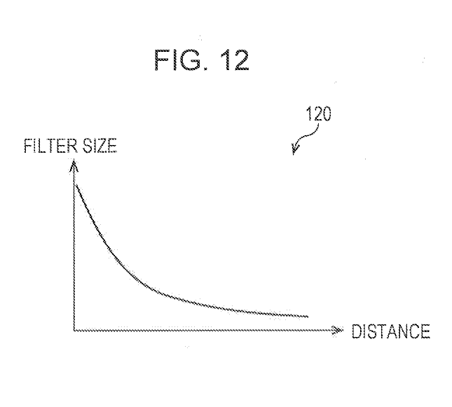

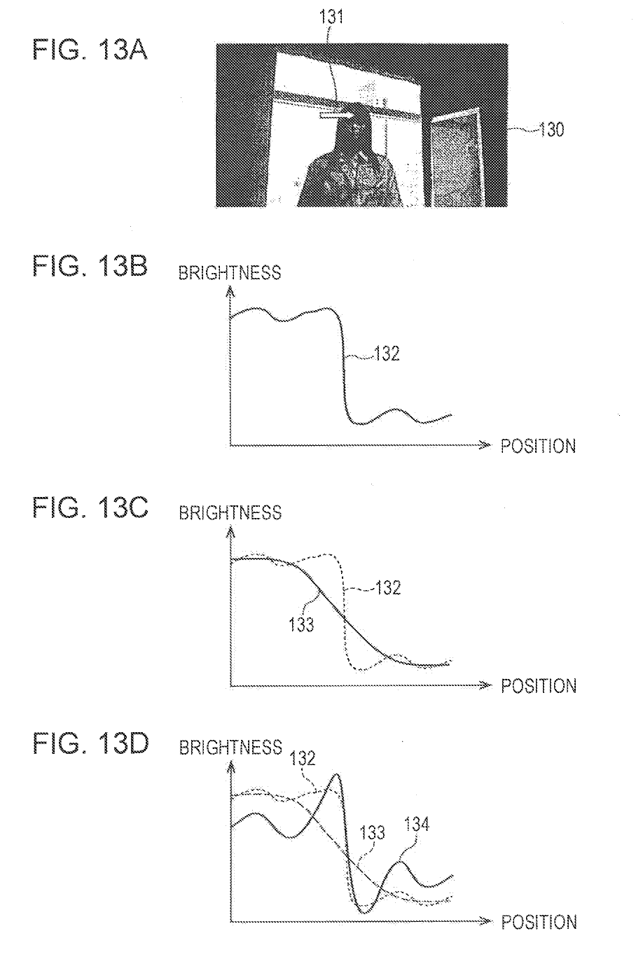

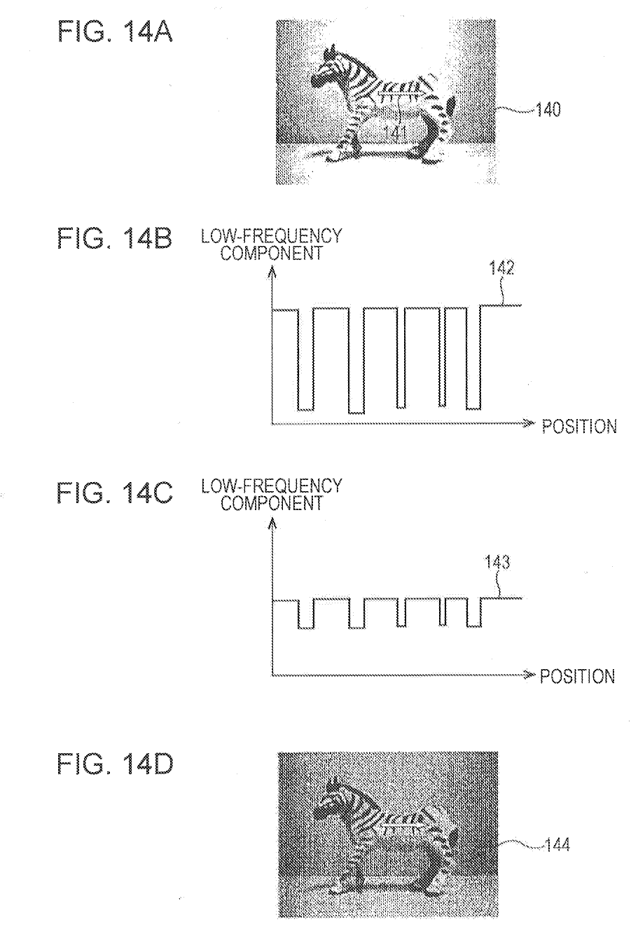

Described below with reference to FIG. 12 is an example of the modification of the size of the filter that calculates the illumination light component in response to the distance to the subject. As illustrated by a graph 120 of FIG. 12, the filter size may be reduced in response to an increase in the distance to the subject. More specifically, an area to be referenced as a peripheral pixel is simply reduced as the distance to the subject represented by the distance information corresponding to the target pixel increases. In this way, the reduction of the filter size responsive to the distance to the subject provides the effect of decreasing an amount of calculation in the calculation of the illumination light component.

The use of the high-frequency component H of the input image leads to a further image quality improvement effect. The image pickup apparatus 1a of FIG. 3 includes the H calculating unit 31 and the H adder 36. If the L compression unit 35 performs the gradation conversion process to compress the illumination light component L, in the edge surrounding area of the illumination light component L, an area on one side where the value of the illumination light component L is low becomes brighter and an area on the other side where the value of the illumination light component L is high is restrained in brightness. The contrast of the illumination light component L in the edge surrounding area considerably decreases.

The H adder 36 then adds the high-frequency component H of the input image calculated by the H calculating unit 31 to the image that has undergone the gradation conversion process to compress the illumination light component L. The contrast of the illumination light component L in the edge surrounding area is increased, leading to an increase in the image quality.

A still sufficient image quality improvement effect results without adding the illumination light component. In such a case, the H adder 36 is not included, and the output value from the L compression unit 35, namely, in the above example, the RGB values with the illumination light component compressed through the process of Expression (1), and Expressions (8) through (10), are simply output as an output image.

Even when the high-frequency component is to be added, the illumination light component may be increased as described in PTL 1 and then the high-frequency component may be added. However, if the high-frequency component is not to be added, an area that suffers from a decrease in contrast is limited to the edge surrounding area of the illumination light component and the contrast of the remaining area is maintained. If the increased high-frequency components are added, the advantages of the present invention are sufficiently provided by performing an adjustment so that the edge is not excessively accentuated.

In accordance with the present embodiment as described above, the illumination light component of the input image is calculated in view of the distance to the subject, the calculated illumination light component is compressed, and the gradation conversion process is performed to maintain the reflectance component. The input image is thus converted into an image with halos controlled and a high contrast from a dark portion to a light portion. By adding the high-frequency component of the input image, a high-quality image with an even higher contrast results.

### Second Embodiment

The image pickup device having the image processing device that performs the image processing has been described as the first embodiment. The image processing device of the present invention (the image processing device 10 of FIG. 1 and the image processing device 30 of FIG. 3) is not necessarily included in the image pickup device of FIG. 1 and FIG. 3. For example, the same advantageous effects may be provided if the image processing device is included in a display device such as a liquid-crystal display. If the image processing device is included in the display device, the display device receives an input image and distance information. As in the first embodiment, the image processing device performs the image processing on the input image to convert the input image into a high-contrast output image with halos controlled, and displays the output image on the display device.

Only the images of the left and right cameras C_{L} and C_{R} may be input but the distance information may not be input. In such a case, the display device calculates the parallax of the left and right cameras C_{L} and C_{R} and uses the parallax as the distance information. The image processing device of the present invention may be included not only in the display device, but also in a personal computer (PC), a video device such as, blu-ray recorder. The image processing device thus converts the input image into a high-contrast output image with halos controlled.

### Configurations of First and Second Embodiments

Elements of the image processing apparatuses of the present invention, for example, nits 11 through 13 in the image processing device 10 of FIG. 1, or units 31 through 36 in the image processing device 30 of FIG. 3 are implemented using hardware including a microprocessor (or DSP: Digital Signal Processor), memory, bus, interface, and peripheral device, and software executable on the hardware. Part or whole of the hardware may be implemented as an integrated circuit/IC (Integrated Circuit) chip. In such a case, the software may be simply stored on the memory. All the elements of the present invention may be implemented using hardware. In such a case, part or whole of the hardware may be implemented using an integrated circuit/IC chip.

A recording medium having recorded a program code of the software to implement the function of the above-described variety of configurations may be supplied to the display device, the PC, the recorder, and the like, and the microprocessor or the DSP in the device may execute the program code. The object of the present invention is thus achieved. In such a case, the program code itself of the software implements the functions of the variety of configurations. The present invention includes the program code itself, and the recording medium having stored the program code (an external recording medium and an internal storage device) on condition that a controller reads and executes the code. The external recording media include a variety of media including optical disks, such as CD, DVD, and BD, and a semiconductor memory such as a memory card. The internal storage devices include a hard disk and a semiconductor memory. The program code may be downloaded from the Internet, and then executed. Also, the program code may be received via a broadcast wave, and then executed.

### REFERENCE SIGNS LIST

1 and 1a . . . image pickup devices, 10 and 30 . . . image processing devices, 11 and 32 . . . brightness (Y) calculating units, 12 and 34 . . . illumination light component (L) calculating units, 13 and 35 . . . illumination light component (L) compression units, 31 . . . high-frequency component (H) calculating unit, 33 . . . parallax calculating unit, 36 . . . high-frequency component (H) adder, C_{R} . . . right camera, C_{L} . . . left camera, and S . . . shutter

1. An image processing device that calculates an illumination light component of an input image from brightness of a target pixel and brightness of a peripheral pixel and performs a gradation conversion process on the input image in accordance with the illumination light component,
configured to vary a weight to brightness on the illumination light component in response to a difference between distance information responsive to the target pixel, calculated from distance information indicating a distance to a subject in the input image, and distance information responsive to the peripheral pixel, calculated from the distance information indicating the distance to the subject in the input image, and
configured to calculate an area that is referenced as the peripheral pixel and is different in response to the distance information responsive to the target pixel.

2. The image processing device according to claim 1, wherein the illumination light component is calculated by reducing more in size the area referenced as the peripheral pixel as the distance to the subject represented by the distance information responsive to the target pixel is longer.

3. The image processing device according to claim 1, wherein a high-frequency component extracted from the input image is added to an image as a result of the gradation conversion process.

4. An image pickup device comprising the image processing device according to claim 1, wherein an image picked up is input to the image processing device as the input image.
